(19) United States
(12) Patent Application Publication
(10) Pub. No.: US 2021/0012990 A1
(43) Pub. Date: Jan. 14, 2021

(54) ARMATURE OF RELAY

(71) Applicant: SUNG-JEN WU, NEW TAIPEI CITY (TW)

(72) Inventor: SUNG-JEN WU, NEW TAIPEI CITY (TW)

(21) Appl. No.: 17/035,590

(22) Filed: Sep. 28, 2020

Related U.S. Application Data
(63) Continuation-in-part of application No. 16/166,341, filed on Oct. 22, 2018.

(51) Int. Cl. H01H 50/18; H01H 50/02; H01H 50/44; H01H 50/54

(52) U.S. Cl. CPC H01H 50/18; H01H 50/54; H01H 50/44; H01H 50/02

(57) ABSTRACT

A relay includes a case and a coil unit is located in the case. Multiple first legs each have the first end thereof connected to the coil unit, and the second end thereof extending beyond the case. A second leg has the first end thereof located in the case and forms a contact, and the second end of the second leg extends beyond the case. A third leg includes an upright section and a transverse section which extends from the upright section and located in the case. The upright section has one end thereof extending beyond the case. An armature has a connection section connected to the transverse section, and a main section located beneath the contact. The main section includes a trapezoid-shaped recess defined in each of two sides thereof to save manufacturing cost. The connection section increases conductive area and flexibility of the armature in the case.

This patent application is a Continuation-In-Part patent application of applicant's former patent application with the application Ser. No. 16/166,341, filed on Oct. 22, 2018.

### BACKGROUND OF THE INVENTION

### 1. Fields of the Invention

### 2. Descriptions of Related Art

The conventional relay includes an input circuit and an output circuit so as to use small current to control large current to protect the electric devices. The room in relays is limited so that the armature installed in the relay has a limited space to pivot. Conventionally, one end of the armature is welded to the leg of the relay so that the range that the armature is limited. Another problem is that if a larger current is needed to be controlled, a shorter armature may cause overflow and burning.

The present invention is intended to provide an armature of a relay, and the purpose is to increase the main section of the armature to successfully use small current to control large current.

### SUMMARY OF THE INVENTION

The purpose of the present invention is to make the armature in the relay be more flexible and stable within the room of the case of the relay, such that the armature is cable to work under high current.

The present invention relates to a relay and comprises a case having a room defined therein, and a coil unit is located in the room. Multiple first legs each have the first end thereof connected to the coil unit, and the second end of each first leg extends beyond the case. A second leg has the first end thereof located in the room and forms a contact, and the second end of the second leg extends beyond the case. A third leg has an upright section and a transverse section. The transverse section extends from one side of the first end of the upright section and is located in the case. The upright section has the second end thereof extending beyond the case. An armature has a connection section and a main section, wherein the connection section is connected to the transverse section, and a bent portion is formed between the connection section and the main section. The main section includes a recess defined in each of two sides thereof. The width of each recess is gradually narrower from the side that the recess is formed of the main section toward the inner end of the recess. The distal end of the main section is located beneath the contact. The connection section increases conductive area and flexibility of the armature in the room.

Preferably, the main section includes a first portion, a second portion and a neck which is formed between the first and second portions, the first portion extends from the bent portion, a length of the first portion is longer than a length of each of the connection section, the second portion and the neck, the first portion and the second portion are located on two different planes, and the neck is inclinedly connected between the first portion and the second portion.

Preferably, the two recesses are formed in the two sides of the first portion of the main section. Each recess is a trapezoid-shaped recess and forms an opening in the side of the first portion. The distance from the opening to the inner bottom of each recess is larger than one-tenth of the width of the first portion of the main section.

Preferably, the length of the main section is defined as “A”. the length of the first portion is defined as “a1”. The length of the second portion 623 is defined as “a2”. The length of the neck is defined as “a3”, wherein A=a1+a2+a3.

Preferably, the case includes a body and a housing which is mounted to the body. The room is formed in the body. The coil unit includes a coil seat, a conductive plate and a driving member. The first ends of the multiple first legs are connected to two ends of the coil set. The first end of the conductive plate is located between the coils seat and the armature. The second end of the conductive plate resiliently contacts the coils seat, or is removed from the coils seat. The driving member is connected to the first end of the conductive plate. The conductive plate pivots when the conductive plate is magnetically attracted by the coil seat, and the driving member controls the armature to pivot. The main section of the armature contacts the contact when the armature pivots. A circuit is formed between the coil unit, the first legs, the second leg, the third leg and the armature.

The advantages of the present invention are that the first portion includes two recesses defined in two sides thereof so as to save manufacturing cost without compromise to its function.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the relay of the present invention;

FIG. 2 shows the relay of the present invention without the housing;

FIG. 3 is a plan view of the relay of the present invention;

FIG. 4 shows another plan view of the relay of the present invention;

FIG. 5 shows that the armature connected to the third leg of the relay of the present invention;

FIG. 5A is an exploded view to show the armature and the third leg of the relay of the present invention, and

FIG. 6 shows the side view of the disclosure of FIG. 5.

### DETAILED DESCRIPTION OF THE PREFERRED EMBODIMENT

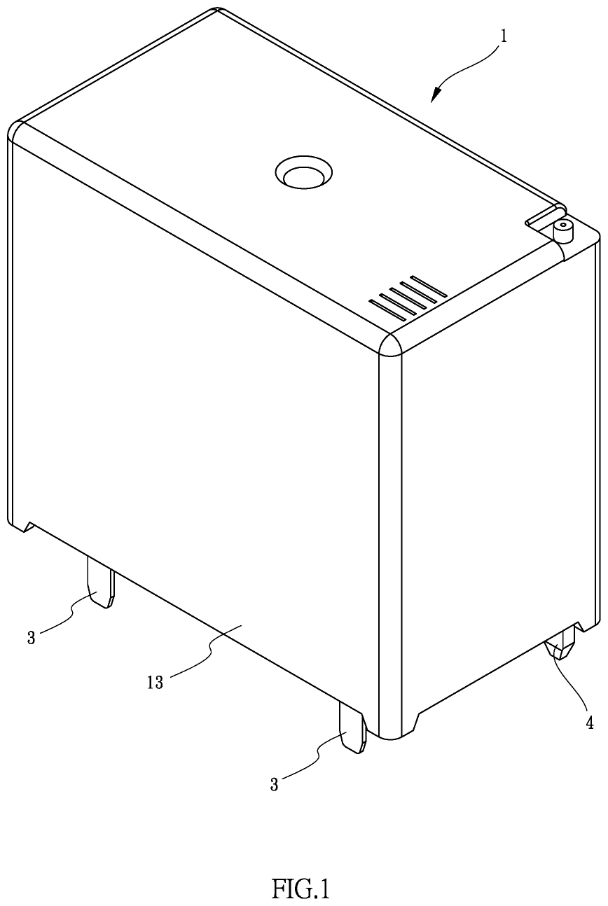

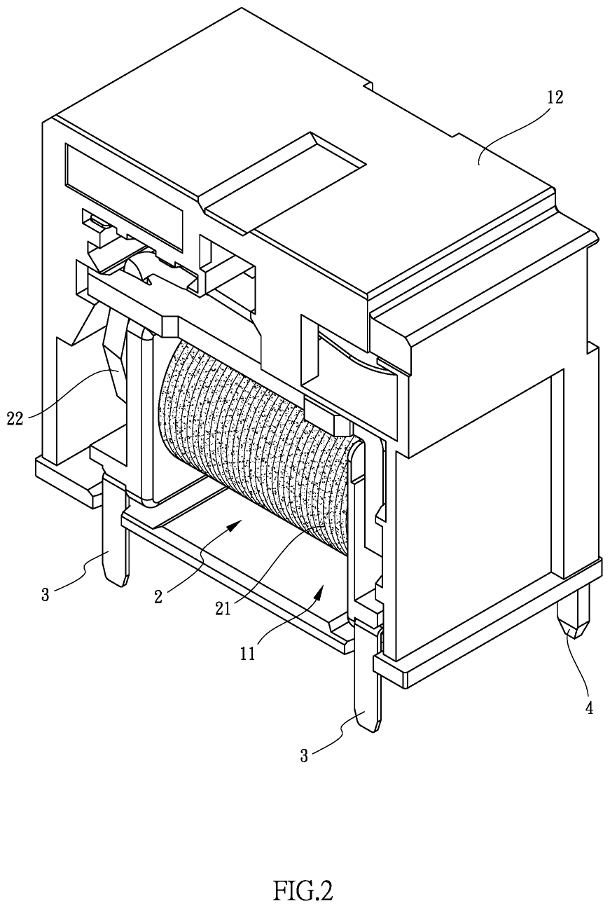

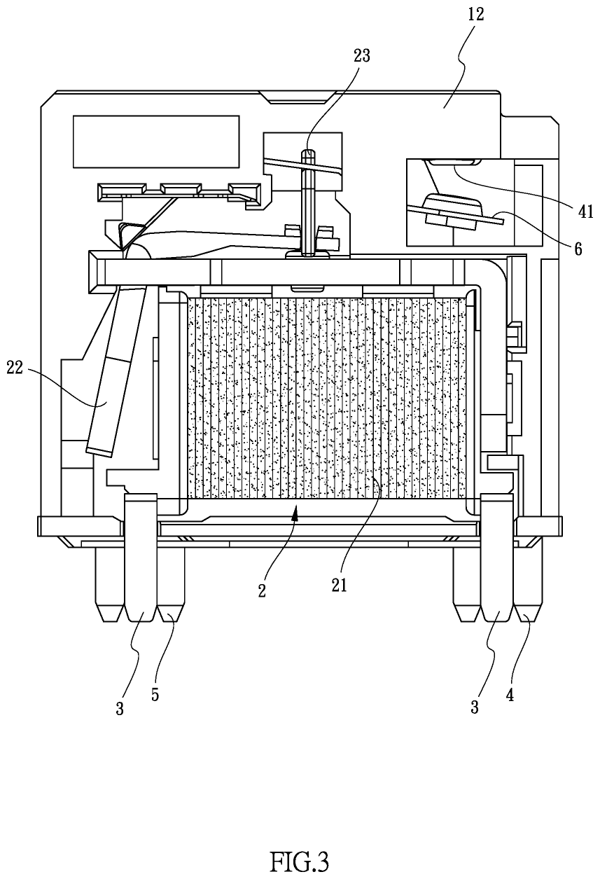

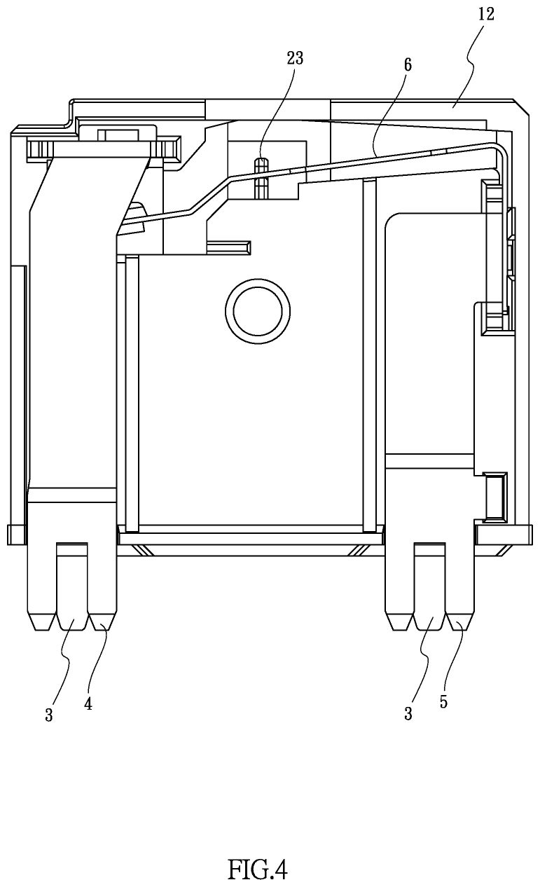

Referring to FIGS. 1 to 5, 5A and 6, the relay of the present invention comprises a case 1 which is a rectangular case and has a room 11 defined therein. Specifically, the case 1 includes a body 12 and a housing 13 which is mounted to the body 12. The room 11 is formed in the body 12. A coil unit 2 is located in the room 11. Multiple first legs 3 each have the first end thereof connected to the coil unit 2, and the second end of each first leg 3 extending beyond the case 1. The second ends of all of the first legs 3 are located on the first side of the case 1. A second leg 4 has the first end thereof located in the room 11 and forms a contact 41, and the second end of the second leg 4 extends beyond the case 1 and located one the second side of the case 1. A third leg 5 includes an upright section 51 and a transverse section 52, wherein the transverse section 52 extends from one side of the first end of the upright section 51 and is located in the case 1. The upright section 51 has the second end thereof extending beyond the case 1.

An armature 6 is located in the room 11 and includes a connection section 61 and a main section 62. The connection section 61 is riveted to the transverse section 52. A bent portion 63 is formed between the connection section 61 and the main section 62. The main section 62 further includes a recess 627 defined in each of two sides thereof. The width of each recess 627 is gradually narrower from the side that the recess 627 is formed of the main section 62 toward the inner end of the recess 627. The distal end of the main section 62 located beneath the contact 41. A gap is formed between the transverse section 52 and the bent portion 63. The connection section 61 is configured to increase conductive area and flexibility of the armature 6 in the room 11. In other words, after the coil unit 2 is activated, the armature 6 is more flexible than the conventional armature such that the contact between the armature 6 and the contact 41 is more accurate.

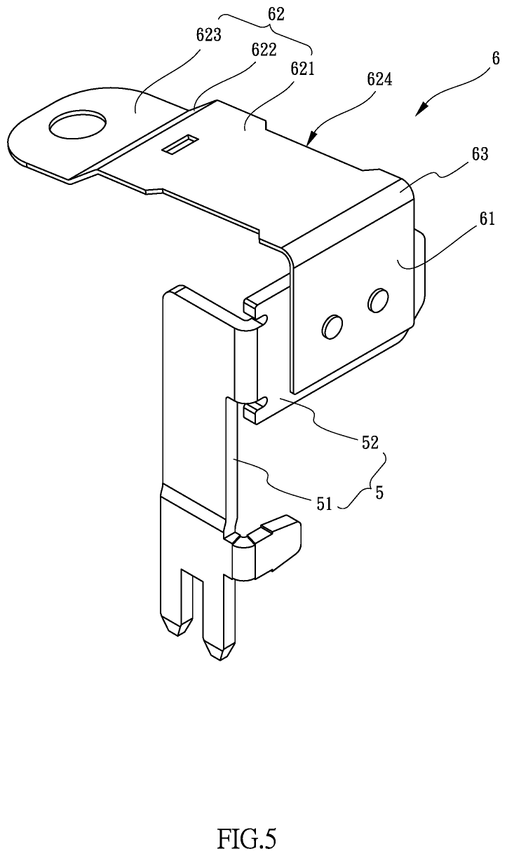

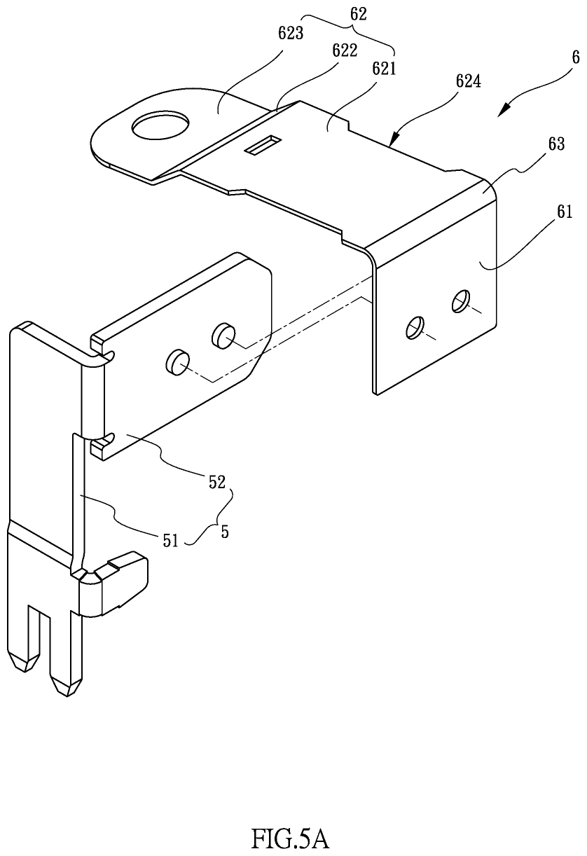

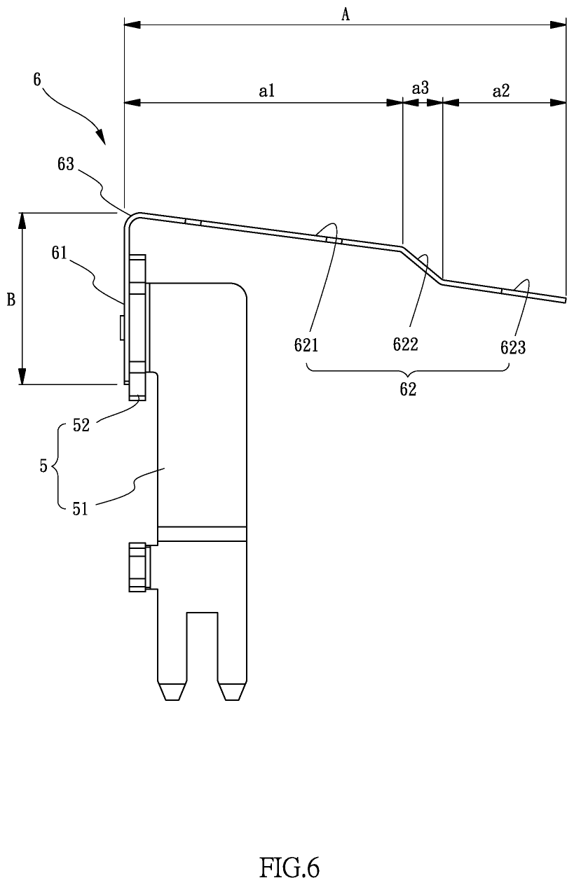

The armature 6 of the present invention includes the bent portion 63 and the connection section 61, and both of which are not provided for the conventional armature 6. As shown in FIGS. 5A and 6, the length of the main section 62, including the bent portion 63, is defined as “A”, and the length of the connection section 61 is defined as “B”. The conventional armature only includes the “A” so that the flexibility of the conventional armature is restricted by the position where the rivets are located. The armature 6 of the present invention includes the connection section 61 so that the total length of the armature 6 is “A”+“B”. Besides, the bent portion 63 is located close to the transverse section 52, so that the main section 62 is more flexible and the range that the main section 62 pivots is wider so as to accurately contact the contact 41 of the second leg 4. Therefore, the relay can be made smaller while the armature 6 works as expected.

The main section 62 includes a first portion 621, a second portion 623 and a neck 622 which is formed between the first and second portions 621, 623. The first portion 621 is formed with the bent portion 63 which is formed between the first portion 621 and the connection section 61. The length of the main section 62 is defined as “A”. The length of the first portion 621 is defined as “a1”. The length of the second portion 623 is defined as “a2”, and the length of the neck 622 is defined as “a3”, wherein A=a1+a2+a3. The length of the first portion 621 is longer than the length of each of the connection section 61, the second portion 623 and the neck 622. The first portion 621 and the second portion 623 are located on two different planes, and the neck 622 is inclinedly connected between the first portion 621 and the second portion 623. In this embodiment, the two recesses 627 are formed in two sides of the first portion 621 of the main section 62. Each recess 627 is a trapezoid-shaped recess and forms an opening in the side of the first portion 621. The distance from the opening to the inner bottom of each recess 627 is larger than one-tenth of the width of the first portion 621 of the main section 62. The recesses 627 formed to the two sides of the first portion o621 of the main section 62 save manufacturing cost without compromise to the desired function of the armature 6.

The coil unit 2 includes a coil seat 21, a conductive plate 22 and a driving member 23. The first ends of the multiple first legs 3 are connected to two ends of the coil set 21. The second ends of the multiple first legs 3 extend beyond the body 12. The first end of the conductive plate 22 is located between the coils seat 21 and the armature 6, and the second end of the conductive plate 22 resiliently contacts the coils seat 21 or is removed from the coils seat 21. The driving member 23 is connected to the first end of the conductive plate 22 that is located between the coils seat 21 and the armature 6. The conductive plate 22 pivots when the conductive plate 22 is magnetically attracted by the coil seat 21, and the driving member 23 controls the armature 6 to pivot. The main section 62 of the armature 6 contacts the contact 41 when the armature 6 pivots, so that a circuit is formed between the coil unit 2, the first legs 3, the second leg 4, the third leg 5 and the armature 6.

While we have shown and described the embodiment in accordance with the present invention, it should be clear to those skilled in the art that further embodiments may be made without departing from the scope of the present invention.

What is claimed is:

1. A relay comprising:
a case having a room defined therein;
a coil unit located in the room;
multiple first legs each having a first end thereof connected to the coil unit, and a second end of each first leg extending beyond the case;
a second leg having a first end thereof located in the room and forming a contact, a second end of the second leg extending beyond the case;
a third leg having an upright section and a transverse section, the transverse section extending from one side of a first end of the upright section and located in the case, the upright section having a second end thereof extending beyond the case, and
an armature having a connection section and a main section, the connection section connected to the transverse section, a bent portion formed between the connection section and the main section, the bent portion located corresponding to the transverse section of the third leg, a distal end of the main section located beneath the contact, the main section including a recess defined in each of two sides thereof, a width of each recess being narrower from the side that the recess is formed of the main section toward an inner end of the recess, the connection section configured to increase conductive area and flexibility of the armature in the room.

2. The relay as claimed in claim 1, wherein the main section includes a first portion, a second portion and a neck which is formed between the first and second portions, the first portion extends from the bent portion, a length of the first portion is longer than a length of each of the connection section, the second portion and the neck, the first portion and the second portion are located on two different planes, and the neck is inclinedly connected between the first portion and the second portion.

3. The relay as claimed in claim 2, wherein the two recesses are formed in two sides of the first portion of the main section, each recess is a trapezoid-shaped recess and forms an opening in the side of the first portion, a distance from the opening to the inner bottom of each recess is larger than one-tenth of a width of the first portion of the main section.

4. The relay as claimed in claim 2, wherein a length of the main section is defined as “A”, a length of the first portion is defined as “a1”, a length of the second portion is defined as “a2”, a length of the neck is defined as “a3”, wherein A=a1+a2+a3.

5. The relay as claimed in claim 1, wherein the case includes a body and a housing which is mounted to the body, the room is formed in the body, the coil unit includes a coil seat, a conductive plate and a driving member, the first ends of the multiple first legs are connected to two ends of the coil seat, a first end of the conductive plate is located between the coils seat and the armature, a second end of the conductive plate is resiliently contact the coils seat or is removed from the coils seat, the driving member is connected to the first end of the conductive plate, the conductive plate pivots when the conductive plate is magnetically attracted by the coil seat, and the driving member controls the armature to pivot, the main section of the armature contacts the contact when the armature pivots, a circuit is formed between the coil unit, the first legs, the second leg, the third leg and the armature.

6. The relay as claimed in claim 4, wherein the case includes a body and a housing which is mounted to the body, the room is formed in the body, the coil unit includes a coil seat, a conductive plate and a driving member, the first ends of the multiple first legs are connected to two ends of the coil seat, a first end of the conductive plate is located between the coils seat and the armature, a second end of the conductive plate is resiliently contact the coils seat or is removed from the coils seat, the driving member is connected to the first end of the conductive plate, the conductive plate pivots when the conductive plate is magnetically attracted by the coil seat, and the driving member controls the armature to pivot, the main section of the armature contacts the contact when the armature pivots, a circuit is formed between the coil unit, the first legs, the second leg, the third leg and the armature.
